(19) United States
(12) Patent Application Publication
(10) Pub. No.: US 2007/0128334 A1
(43) Pub. Date: Jun. 7, 2007

(54) ADDITIVES TO ENHANCE VARIOUS DISTILLERS GRAINS

(76) Inventor: William Pittman, Moorhead, MN (US)

Correspondence Address: JUSTIN LAMPEL, 2111 PRIMROSE LANE, SCHAUMBURG, IL, 60194, US

(21) Appl. No.: 11/164,744

(22) Filed: Dec. 4, 2005

(51) Int. Cl. A23K 1/00

(52) U.S. Cl. 426/623

(57) ABSTRACT

A method for producing an improved livestock feed mixture. The method has the steps of adding zeolites and/or activated carbons to the byproducts of ethanol production and/or other fermentation processes. The addition of the zeolites and/or activated carbons extends the shelf life of the feed mixture prior to consumption by livestock. Further, vitamins, minerals and/or other substances may be added to the zeolites and/or activated carbons to further increase the nutritional value of the feed mixture. The method results in a consistent feed mixture produced from the byproducts of ethanol production and/or other fermentation processes.

### BACKGROUND OF THE INVENTION

This invention relates to a process for creating improved livestock feed mixture from the byproducts of ethanol or other fermentation and/or grain processing. The process involves adding zeolites and/or activated carbon to the end products of ethanol and/or other fermentation. More specifically, granulated and/or powdered zeolites and/or activated carbon are added to distillers dried grains and solubles, distillers dried grains, distillers grain, or any combination thereof, at a rate of 0.01% to 10% by weight volume at approximately 0-300 degrees Celsius. The zeolites and/or activated carbons may be granulated and/or powdered. Further, the zeolites and/or activated carbons may be virgin or impregnated with minerals, vitamins, chemicals and/or other nutrients. After the zeolites and/or activated carbons are added, the new feed mixture is more cost effective and/or will have a more consistent feed value. In addition, the new feed mixture will require less energy in the drying process because the feed mixture will have less moisture. As a result, the shelf life and nutritional value of the end product is increased and the cost of drying the mixture is reduced.

One gram of zeolite provides several hundred square meters of surface area where chemical reactions can take place. Zeolites can absorb up to 40% of their dry weight in gases such as nitrogen and ammonia and over 70% of their dry weight in water and up to 90% of certain hydrocarbons.

Zeolites are a group of about 50 mineral types. Among them, clinoptilolite is the most abundant and commonly used zeolite mineral. Zeolite minerals form from volcanic sediments under conditions of high pH and in the presence of silicon and aluminum. They exist in rock formations in the United States and around the world.

The residue from the production of ethanol and/or other fermentation, from corn or other grains, is a high moisture mix that is difficult to transport. The mix generally has the consistency of approximately over 50% moisture for Distillers Modified Wet Grain (DMWG) and approximately over 12% moisture for Distillers Dried Grains and Solubles (DDGS). Because the DMWG mix is highly fluid, it has a short shelf-life and is not suitable for extended travel time and/or storage prior to consumption by livestock. Further, DMWG is prone to caking and does not flow well through handling equipment. Still further, because the byproducts of the ethanol production or other fermentation lack the necessary carbohydrates for the livestock, such products deprive the livestock of a complete necessary dietary supplement. More specifically, the carbohydrates present in grains or other beginning substances are converted by enzymes into ethanol during ethanol production. Thus, the remaining mix substantially lacks carbohydrates necessary for a proper diet.

Distillers Dried Grains with Solubles is the product obtained by condensing and drying the stillage remaining after removal of ethyl alcohol by distillation from yeast fermentation of grain or grain mixture. According to Badger State Ethanol, Inc., the typical analysis of DDGS is as follows:

| | | | |
|---|---|---|---|
| Dry matter % | 88.27 | ADF % | 17.06 |
| Moisture % | 11.73 | NDF % | 34.31 |
| Crude protein % | 31.05 | Fat % | 15.24 |
| RUP % | 59.10 | Calcium % | 0.06 |
| NEL (Mcal/lb) | 1.0803 | Phosphorous % | 0.89 |
| NEG (Mcal/lb) | 0.7928 | Magnesium % | 0.38 |
| NEM (Mcal/lb) | 1.1255 | Potassium % | 1.23 |
| NFC % | 21.74 | D.C.A.D. (mEq/lb) | −33.13 |

To reduce the problem with the lack of carbohydrates, the zeolites and/or activated carbons may be impregnated with, for example, urea, ammonia, carbohydrates, sugars and/or other nutrients. More specifically, the urea and/or ammonia impregnated into zeolites and/or activated carbons may be carried into the digestive system of the animal and, through bacterial interaction, be released as carbohydrates or sugars.

For nearly fifty years, farmers have been providing feedblocks to livestock in an attempt to compensate for the lack of a proper nutritional diet. These typical feedblocks are good at providing energy, protein, minerals, and/or vitamins to the livestock. They usually consist of dried molasses, urea, oil seed meal, minerals, and vitamins.

Feedblock production generally is accomplished by two methods. The first involves the production of feedblocks from extreme physical compression of materials. More specifically, the production of these feedblocks usually requires the pouring of the byproducts of the ethanol production or other fermentation process into molds where they are allowed to cure. The second method involves the production of feedblocks by means of utilizing a reaction involving metal oxides, such as calcium and magnesium oxide, and water bearing nutrient media, such as molasses, and a variety of other agents.

However, these feedblocks are not produced by the method of the present invention. Further, theses known feedblocks do not provide the necessary dietary nutritional supplements that are provided by the method for creating a feed mixture as in the present invention.

The method of the present invention utilizes zeolites and/or activated carbons to produce a highly beneficial feed mixture from the byproducts of ethanol production and or other fermentation processes. More specifically, the addition of zeolites and/or activated carbons to the ethanol production byproducts and/or other fermentation byproducts substantially extends the shelf life of the feed mixture and also has positive dietary effects on the livestock.

Zeolites, or molecular sieves as they are sometimes called, are microporous crystalline solids with well-defined structures. Usually, zeolites contain oxygen, silicon and aluminum within their framework and contain water, cations and/or other molecules within their pores. In the United States, zeolites are used in petrochemical cracking, ion-exchange (water softening and purification), and in the separation and removal of gases and solvents. In addition, zeolites are often used in construction and husbandry. This invention relates to the use of zeolites and/or activated carbon in husbandry. More specifically, this invention relates to the use of zeolites and/or activated carbons for the health of animals.

Zeolites are made up of four connected networks of atoms. Zeolites generally take the form of a tetrahedral. The silicon atom of the zeolite is located in the middle and the oxygen atoms are located at the corners. The tetrahedral can then be linked by their corners. The framework structure may contain linked cages, cavities or channels, which are of a size in which a small molecule may enter. The limiting pore sizes are roughly between 3 and 10 Å in diameter.

Zeolites are capable of specific molecular absorption because of their unique molecular shape. This allows zeolites to act as molecular sieves. Zeolites can selectively separate solutions by either 1) because of the size and shape of the pores controlling access into the zeolite or 2) the solutions are separated because different molecules in the solution diffuse through the channels of the zeolite more quickly than other molecules, leaving the other molecules stuck behind.

Cation-containing zeolites are commonly used as desiccants because they have a high affinity for water. Alternatively, hydrophobic silica zeolites preferentially absorb organic solvents. Thus, zeolites can separate molecules based on different sizes, shapes and/or polarity.

In addition to zeolites, activated carbon molecules act as powerful absorbents. Further, they are often used to decolorize liquids, recover solvents and remove toxins from air or water. Activated carbons are non-hazardous, processed, carbonaceous products, having a porous structure and a large internal surface area. As a result, activated carbons are capable of absorbing a large variety of substances. More specifically, they are capable of attracting different molecules to their internal surface (therefore called an absorbent). The volume of the pores of the activated carbons is generally larger than 0.2 ml g⁻¹. The internal surface area is generally greater than 400 m² g⁻¹. The width of the pores ranges from 0.3 to several thousand nm.

It is well known that activated carbons are extremely effective in removal of many toxins from the body. In 1831, French medical Professor Touery lived after intentionally drinking a lethal dose of strychnine, but only because he combined the poison with activated charcoal. The activated carbon and/or zeolite may act as an emergency decontaminant in the gastrointestinal tract (GI).

Because of its porous interior, activated carbon may be used for the removal of ammonia from a solution. More specifically, the activated carbon is impregnated with phosphoric acid. The phosphoric acid then interacts with the free ammonia and removes the free ammonia. The process follows the following equation:
H₃P0₄+3NH₃=(NH₄)₃P0₄

Studies have shown that activated carbons can reduce the amount of poisonous substances being absorbed by the body by as much as 60%. In fact, a fine black powder of activated carbon is often given after gastric lavage, or stomach pumping. Mycotoxin contamination of livestock feed costs farmers billions of dollars a year worldwide in disease and productivity. An animal suffering from mycotoxin contamination often has a reduction in body weight, immunosuppressant and reproduction. As a result, when activated carbon is added to a feed mixture, the amount of toxins in the body may be reduced.

Currently, the byproducts of the production of ethanol and or other fermentation processes are feed largely unchanged to livestock. These processes involve the utilize condensed dry solubles (cds), distillers dry grains with solubles (ddgs), distillers grain with solubles (dgs), distillers dry grain (ddg), distillers grain (dg), wet and dry sugar beet pulp and other starting biological material. Although these byproducts are edible, they do not provide a complete additive nutritional diet for the livestock. Further, because the byproducts spoil readily, they must be dried or feed to the livestock not long after the ethanol production or other fermentation process.

As a result, it is common for the existing byproducts of ethanol production and/or other fermentation to be discarded rather than used as a food source. This is a result of the short shelf life and poor nutritional value of the byproducts.

In order to solve this problem, farmers have used zeolites to dry and increase the value of the byproducts of ethanol production and other fermentation to create rigid feed blocks. These feedblocks are used primarily as supplements, as opposed to a normal food source, for the livestock. Further these known uses do not utilize activated carbons and/or zeolites to increase the feed value of the byproducts of fermentation and/or grain processing.

In addition to the use of zeolites and/or activated carbon to increase the feed value of the byproducts of fermentation and/or grain processing, known feed mixtures do not utilize activated carbons and/or zeolites to act as an absorbent to help remove alfatoxins (a carcinogenic toxin) and/or mycotoxins (a toxic substance produced by a fungus and especially a mold), or other potential illness causing substances, caused by ingestion or spoiled or contaminated mixtures.

Wet distilled grains (WDGs) is the grain residue after dewatering of the products of ethanol production and other fermentation products. WDG is approximately 50% moisture. As a result, the shelf life for WDG is short. Adding zeolites and/or activated carbons often may significantly dry the WDG and increase the shelf life of the WDG, thereby decreasing spoilage. The amount of zeolites and/or activated carbon added to the WDG depends on the desired product, for example, which type animal will receive the mixture.

Finally, zeolites and/or activated carbons may be added to versions of distillers grains as a result of their anti-caking qualities. More specifically, the anti-caking quality of the zeolites and/or activated carbons greatly improves the flow of the grains. This decreases the need for special handling equipment and special procedures needed to transport, store and feed to the animals.

Flowability of distillers dried grains and solubles (DDGS) is a significant problem for many ethanol manufacturing plants. Particle size, the amount of residual sugars and proper cooling of DDGS prior to loading affects the ability of the DDGS to flow out of feed bins, trucks, rail cars and containers. This problem is most serious during hot, humid weather and often results in a significant increase in costs due to increased labor and the extensive damage caused when attempting to unload the product.

A need, therefore, exists for an improved method for producing a livestock feed mix. The feed mix utilizes the byproducts of ethanol production and/or other fermentation processes. More specifically, zeolites and/or activated carbons are added to the byproducts to create an improved feed mix which is healthier and may have a longer shelf life. Unlike most feed mix, the adding of the zeolites and/or activated carbons results in an improved feed mix which is consistent from day to day and from plant to plant. As a result, a safe and reliable mix can be feed to livestock.

### SUMMARY OF THE INVENTION

The invention is drawn toward a method for producing an improved feed mix for livestock. The feed mix is produced by inserting zeolites and/or activated carbons into the byproducts of ethanol production or other fermentation. Because of the hydrophilic nature of zeolites and activated carbons, the newly created feed mix has a lower moisture level than existing feed mixtures. Further, less energy consumption is required for the drying of the feed mix. As a result, the feed mix of the present method has a longer shelf life than existing feed mixes created from the byproducts of the ethanol production or other fermentation processes.

The residue from the production of ethanol, from corn or other grains, if not dried, is a high moisture feed mix that is difficult to transport, store and dispense. Further, the feed mix has a short shelf-life. Adding zeolites and/or activated carbons to the feed mix will produce a feed mix which is far superior to existing fee mixes produced from the byproducts of the production of ethanol or other grain processing.

To this end, in an embodiment of the invention, a method for producing a novel feed mix is provided which includes the byproducts of fermentation, zeolites and/or activated carbon.

In another embodiment, the method requires the feed mix to be dried as a result of the addition of the zeolites and/or activated carbons with hydrophilic properties.

In an embodiment, the present method for producing a livestock feed mix requires less energy to dry the feed mix than existing methods of creating a feed mix.

In still another embodiment, the method increases the value of the feed mix by adding zeolites and/or activated carbon to the byproducts of ethanol production and/or other fermentation processes.

In yet another embodiment, the method of the present invention produces a feed mix with a high degree of consistency from ethanol plant to ethanol plant.

In still another embodiment of the present method, the nutritional value varies from plant to plant.

In yet another embodiment, the method requires the zeolites and/or activated carbons to be impregnated with a food enhancing product such as, vitamins, minerals, medicines and/or other nutrients.

In another embodiment, the method requires the activated carbons and/or zeolites of the feed mix to absorb moisture in the feed mix.

In still another embodiment, the method requires the zeolites and/or the activated carbons to absorb toxins located within the digestive track of an animal.

In yet another embodiment, the method requires the zeolites and/or activated carbons to absorb ammonia that can later be reabsorbed into the digestive system of the livestock.

In an embodiment, the method requires the ammonia absorbed into the digestive system to be broken down by bacteria and/or enzymes into carbohydrates.

And in an embodiment, the method requires the zeolites and/or activated carbons to be impregnated with urea or other chemicals to restore the sugars lost in the manufacturer of the ethanol.

In another embodiment, the method requires the zeolites and/or activated carbons to be adaptable to all distillers dried grains, distillers dried grains and solubles, brewers grains and/or any liquid or byproduct of grain or feed processing.

In an embodiment, the method requires the zeolites and/or activated carbons to increase the dryness and flow ability of the feed mix, thereby helping to prevent the caking, spoilage and/or molding of distillers dried grain and solubles.

In an embodiment, the method requires the zeolites and/or activated carbons to be used in screens sized from about 500 mesh to 4×8 mesh sizes.

In still another embodiment, the method requires the zeolites and/or activated carbons to be used in various temperatures from about 0 degrees Celsius to 150 degrees Celsius.

And in an embodiment, the method requires the zeolites and/or activated carbons to remain functional in high moisture or high temperature ranges.

In yet another embodiment, the method requires the zeolites and/or activated carbon to aid in increasing the value of sugar beet pulp and/or other shreds.

In another embodiment, the method requires the zeolites and/or activated carbons to be impregnated with ammonia, thereby helping in the production of carbohydrates in animals.

In still another embodiment, the method requires the zeolites and/or activated carbons to be impregnated with lysine or methane to increase the value of distillers dried grains and solubles or other products.

In an embodiment, the method requires the zeolites and/or activated carbons to be impregnated with antibiotics or other products.

In yet another embodiment, the method requires the zeolites and/or activated carbons to be impregnated with minerals or other products.

And in an embodiment, the method requires the zeolites and/or activated carbons to be impregnated with urea or other chemicals to restore the sugars lost in the manufacturer of the ethanol or other products.

In an embodiment, the method requires the zeolites and/or activated carbons to increase the flow of the various distillers grains during transportation and storage of the distillers grains from the plant to the user.

Finally, in an embodiment, the method requires the zeolites and/or activated carbons to be adaptable to all distillers dried grain, distillers dried grains and solubules, brewers grains or any liquid or byproduct of grain or feed processing.

It is therefore an advantage of the present invention to provide an improved method for producing a feed mixture for livestock.

A further advantage of the present invention is to provide a method for producing a feed mixture from the products of ethanol production or other fermentation processes which has a long shelf life and enhanced feed and safety value.

A still further advantage of the present invention is to provide a method for producing a livestock feed mixture from the byproducts of ethanol production or other fermentation which has an improved nutritional content for the livestock.

A still further advantage of the present invention is to provide a method for drying the feed mixture byproducts of ethanol production and other fermentation which requires less energy than current methods.

For a more complete understanding of the above listed features and advantages of the improved method, reference should be made to the following detailed description of the preferred embodiments. Further, additional features and advantages of the present invention are described in, and will be apparent from, the detailed description of the preferred embodiments.

### DETAILED DESCRIPTION OF THE PREFERRED EMBODIMENTS

This invention relates to a method for creating an improved feed mix for livestock. The method results in an increased nutritional value for the byproducts of ethanol production and/or other fermentation processes. In addition, the method increases the shelf life for the feed mix produced from the byproducts of ethanol production and/or other fermentation processes.

The method involves adding drying substances, such as zeolites and/or activated carbons to the feed mix. Once added, the hydrophilic zeolites and/or activated carbons absorb moisture from the largely liquid feed mixture. As a result, the feed mixture may be stored and/or transported for a longer time prior to consumption then if the zeolites and/or activated carbons were not added. The method is particularly useful for production of highly nutritional feed mix from a largely wasteful by product.

In addition to serving as a nutritional supplement, drying agent and/or anti-caking agent, zeolites have been known to regulate the release of nitrogen from non-protein sources in ruminant feeding and from animal excrement.

Zeolites and/or activated carbons can be added at any time during the drying process, but is preferably added post drying. However, the preferred method of this invention may comprise the following 4 steps:

Step (1)—Obtaining the byproducts of ethanol production and/or other fermentation processes.

Step (2)—Adding zeolites and/or activated carbons to the byproducts of ethanol production and/or other fermentation processes.

Step (3)—Mixing the solution at approximately between 0° and 150° degrees Celsius for approximately 1 second to 10 minutes.

Step (4)—Allowing the solution to cure. Preferably, the mixture cures for approximately 1 second to 10 minutes.

Step 1

The end product of grain processing, such as sugar cane, include ethyl alcohol, a gasoline substitute, rum, sucrose and molasses. The grain may be crushed and the liquid may be placed in a vacuum. While in the vacuum, the liquid may be allowed to boil. While boiling in the vacuum, the water evaporates leaving a high carbohydrate concentration liquid. This process may be repeated. Preferably, the process is repeated twice. Water and yeast may then be added to the remaining liquid to undergo fermentation. In fermentation, yeast utilize the carbohydrates and produce ethanol. After further distillation, the remaining liquid may be discard by manufacturing plants. In the present invention, this liquid may be the first ingredient in the feed mixture.

Step 2

Zeolites and/or activated carbons may be added at any stage of the feed mix preparation process. The timing of the adding of the zeolites and/or activated carbons may depend on the desired product. In an embodiment, after the liquid is obtained from step 1, zeolites and or activated carbons are added to the liquid. More specifically, between approximately 0.01% and 10% zeolite (by weight) and 0.01% and 10% activated carbon (by weight) are added within approximately 10 seconds to 10 minutes after the final distillation process.

If drying the distilled dried grains is a major goal, then the zeolites and/or activated carbons should be added after the initial dewatering or drying process of the products of the ethanol production or other fermentation. In a case, the zeolites and/or activated carbons are added to the remaining products of the ethanol production or other fermentation at a rate of ⅛ oz to 5 oz per pound, depending on the desired type animal feed, ration and dryness desired outcome. The zeolites and/or activated carbons may be virgin or impregnated, depending on the desired product.

Step 3

The liquid/zeolite/activated carbon mixture may then mixed at approximately 0° to 150° degrees Celsius for approximately 10 seconds to 10 minutes. This temperature range and time allows the mixture to properly cure.

Step 4

Finally, the mixture may be allowed to cure. Preferably, the mixture cures from 1 second to 10 minutes; however, it should be understood that the mixture may not cure at all or may cure longer than 10 minutes. Afterward the feed mixture may be feed to livestock. This feed mixture may have an unlimited shelf life, depending on the process used to create the mixture.

Again, due to the wide variation in DDG, DDGS and WDG from plant to plant, the steps taken to produce the mixture may vary depending on the use of the mixture, for example, which animal will receive the mixture.

In another method, additional steps may be followed. For example, vitamins, minerals and/or other substances could be added to the zeolites and/or activated carbons prior to feeding. The addition of these substances is done primarily to increase the nutritional value of the feed mix for the livestock.

In addition, the method may include the step of adding sugar molasses.

Further, the method may include the step of adding bentonite clay. Bentonite clay may also be used as a drying agent, binding agent for toxins and/or a caking agent for pelitizing the distillers grains. Even further, the bentonite clay may help control myotoxin and/or alphatoxin levels in the gastrointestinal tract of animals.

Example Formulas

| Ingredient | EX1 | EX2 | EX3 | EX4 |
|---|---|---|---|---|
| DDGS | ˜40-90% | ˜20-40% | ˜20-40% | ˜10-20% |
| Zeolite | ˜20-40% | ˜1-5% | ˜5-10% | ˜1-5% |
| Activated carbon | ˜20-40% | ˜1-5% | ˜1-5% | ˜1-5% |
| Bentonite Clay | ˜2-4% | ˜4-6% | ˜6-8% | ˜8-10% |
| Other rations | ˜50% | ˜50% | ˜70% | ˜70-80% |

DDG may be up to 95%
DDGS may be up to 95%
WDG may be up to 95%

Distillers dried grains and solubles is a co-product produced by dry mill ethanol plants as a result of fermenting corn starch to produce fuel ethanol and carbon dioxide. Each bushel (25.4 kilograms) of corn fermented in a dry mill ethanol plant will produce approximately 10.2 liters of ethanol, 8.2 kg of carbon dioxide and 8.2 kg of DDGS.

The distillers grains produced by most distilleries from ethanol production and/or the products of other fermentation is often not a consistent feed mixture. As a result, livestock may have digestive problems with constantly being served different compositions of feed mixture. The method of the present invention produces a consistent feed mixture. This feed mixture is beneficial to livestock, not only from a nutritional standpoint, but also because the consistency of the feed is easier for the livestock to digest. Typically, distillers grains contain 10%-15% fat (oil), 40%-45% neutral detergent fiber, 30%-35% crude protein and approximately 5% ash.

When fed to cattle at 10%-20% of the total dry matter, dry distillers grains with solubles has an apparent energy level equal to that of corn grain. Further, feeding DDGS to cattle does not change the quality or yield grades of the carcasses. Even further, the feed cost of the grain may be reduced if the cost of the DDGS is not greater than the cost of the corn grain on a dry basis.

Studies at Iowa State University have shown that feeding dry distillers grain to cattle at 10, 20 or 40% of the ration did not affect feedlot performance or cost of grain. Cattle feed 10% wet distillers grains were 4% more efficient and had 5% lower feed costs of grain. Feeding 40% of ration dry matter as wet distillers grains reduced feed intake and rate or gain with similar feed conversion and cost of gain.

Feeding trials suggest that DDGS contains unidentified growth factors that improve growth, reproduction and feed intake. Poultry that were feed at least 10% DDGS showed improved growth and reproduction. Similarly, increased litter size and pig survivability have been seen in sows fed a diet containing 5% DDGS compared with sows fed a diet containing corn, oats and soybean meal. Studies in Canada also suggest that there is a 25% higher retention of nitrogen in zeolite treated cattle. More specifically, cattle fed zeolite have been shown to have a reduction in odor by trapping 30% of the nitrogen that is loss via aeration.

Preferably, the DDS, DDGS or DWGS zeolite/activated carbon mixture should have a pH greater or equal to 7.5. However, it should be understood that the pH may be of any value between 6-13.

Although embodiments of the present method are described therein, it should be understood that various changes and modifications to the presently preferred embodiments will be apparent to those skilled in the art. Such changes and modifications may be made without departing from the spirit and scope of the present invention and without diminishing its attendant advantages. It is, therefore, intended that such changes and modifications be covered by the appended claims.

1. A process for preparing a distillers grain comprising the steps of:
(a) obtaining the edible distilled byproduct of yeast fermentation;
(b) mixing the byproduct with a zeolite until the byproduct is substantially uniform;
(c) mixing the byproduct with an activated carbon until the byproduct is substantially uniform;
(d) allowing the byproduct mixture to cure for a time sufficient; and
(e) providing the byproduct mixture as a livestock feed.

2. The process of claim 1, wherein the percent of zeolite by weight is between 0.01%-10% of the total byproduct mixture weight.

3. The process of claim 1, wherein the percentage of activated carbon by weight is between 0.01%-10% of the total byproduct mixture weight.

4. The process of claim 1, wherein the zeolite is added between 10 seconds and 10 minutes after the final distillation.

5. The process of claim 1, wherein the activated carbon is added between 10 seconds and 10 minutes after the final distillation.

6. The process of claim 1 further comprising the step of:
allowing the byproduct mixture to substantially dry prior to being feed to livestock.

7. The process of claim 1 further comprising the step of:
impregnating the zeolite with a vitamin, mineral, lysine, methane medicine, nutrient, urea or other food enhancing product.

8. The process of claim 1 further comprising the step of:
impregnating the activated carbon with a vitamin, mineral, lysine, methane medicine, nutrient, urea or other food enhancing product.

9. The process of claim 1, wherein the zeolite and/or activated carbon may absorb mycotoxins in the livestock.

10. The process of claim 1, wherein the zeolites and/or activated carbons absorbs ammonia in the livestock.

11. The process of claim 1 further comprising the step of:
multi-screening the zeolites and/or activated carbon in a mesh screen.

12. The process of claim 1 further comprising the step of:
heating the byproduct mixture from about 0 degrees Celsius to 300 degrees Celsius.

13. The process of claim 1 further comprising the step of:
impregnating the zeolites and/or activated carbons with antibiotics prior to feeding the byproduct mixture to the livestock.

14. The process of claim 1 further comprising the step of:
adding bentonite clay to the byproduct mixture.

15. The process of claim 1, wherein the byproduct mixture has a pH between 6-13.

16. The process of claim 15, wherein the byproduct mixture has a pH between 7.5-10.

17. The process of claim 1, wherein the zeolites and/or activated carbons are granulated.

18. The process of claim 1, wherein the zeolites and/or activated carbons are powdered.

19. The process of claim 1 wherein the zeolites are clinoptilolite zeolites.
